(19) United States
(12) Patent Application Publication
(10) Pub. No.: US 2026/0261289 A1
(43) Pub. Date: Sep. 3, 2026

(54) WIRELESS TELECOMMUNICATIONS NETWORK

(71) Applicant: BRITISH TELECOMMUNICATIONS PUBLIC LIMITED COMPANY, London (GB)

(72) Inventors: Yangyishi ZHANG, London (GB); Fraser BURTON, London (GB)

(21) Appl. No.: 19/489,968

(22) PCT Filed: May 2, 2024
(86) PCT No.: PCT/EP2024/062087

§ 371 Date: Dec. 4, 2025

(30) Foreign Application Priority Data
Jun. 21, 2023 (EP) 23180565.6

(51) Int. Cl. H04B 7/04; H04L 25/02

(52) U.S. Cl. CPC H04B 7/04013; H04L 25/0202

(57) ABSTRACT

This disclosure provides a method of configuring a Reconfigurable Holographic Surface (RHS) in a wireless telecommunications network, a device for implementing the method, and a system including the device, the wireless telecommunications network including a communication channel between the RHS and a receiver, the method including obtaining data indicating a plurality of channel states, each channel state of the plurality of channel states representing one or more properties of the communication channel at a particular time instance being one of a group comprising a historical time instance and a current time instance; predicting a future channel state based on the obtained plurality of channel states, the future channel state representing the communication channel at a future time instance; and causing the RHS to be configured based on the future channel state

### PRIORITY CLAIM

The present application is a National Phase Entry of PCT Application No. PCT/EP2024/062087, filed May 2, 2024, which claims priority from EP Application Serial No. 23180565.6, filed Jun. 21, 2023, each of which is hereby fully incorporated herein by reference.

### TECHNICAL FIELD

The present disclosure relates to a method of transmitting a signal in a wireless telecommunications network comprising a Reconfigurable Holographic Surface.

### BACKGROUND

A wireless telecommunications network typically comprises an access point and a plurality of user equipment. It is desirable to increase the data rate of communications between the access point and each user equipment of the plurality of user equipment, or in other words maximize the sum-rate of communications. It is also desirable to limit the cost of deploying and operating wireless telecommunications networks, such as by reducing the cost of manufacturing and installing access points and reducing the amount of energy consumed by the access points.

Multiple-Input-Multiple-Output (MIMO) is a known technology for improving the sum-rate of communications between an access point and a plurality of user equipment by exploiting spatial diversity. MIMO is typically enabled using antenna arrays, such as phased arrays, which have a high hardware cost and power consumption (relative to access points that do not implement MIMO technology). An emerging antenna technology is known as the Reconfigurable Holographic Surface (RHS). The RHS is an antenna capable of beamforming based on a holographic principle. That is, the RHS records a holographic interference pattern, from which a desired object wave can be reconstructed from a reference wave, in a plurality of metamaterial radiation elements. Relative to phased array based MIMO antennas, the RHS may achieve beamforming using a more compact and lightweight design, has low power consumption and has a low manufacturing cost.

### SUMMARY

According to a first aspect of the disclosure, there is provided a method of configuring a Reconfigurable Holographic Surface (RHS) in a wireless telecommunications network, the wireless telecommunications network comprising a communication channel between the RHS and a receiver, the method comprising: obtaining data indicating a plurality of channel states, each channel state of the plurality of channel states representing one or more properties of the communication channel at a particular time instance being one of a group comprising a historical time instance and a current time instance; predicting a future channel state based on the obtained plurality of channel states, the future channel state representing the communication channel at a future time instance; causing the RHS to be configured based on the future channel state.

The future time instance may represent the time the RHS transmits a signal to the receiver, after configuration based on the future channel state.

Predicting a future channel state may use a time series forecast technique. The time series forecast technique may be based on a long short term memory recurrent neural network. The data indicating the plurality of channel states may include a current channel state representing the communication channel at the current time instance, and configuring the RHS based on the future channel state may comprise: determining an initial configuration of the RHS, determining a difference value between a candidate configuration of the RHS applied to the future channel state and the initial configuration of the RHS applied to the current channel state, determining that the difference value satisfies a condition, and causing the RHS to be configured based on the candidate configuration of the RHS.

Determining the difference value may be repeated iteratively for a plurality of candidate configurations of the RHS, each iteration may comprise determining a difference value between one of the plurality of candidate configurations of the RHS applied to the future channel state and the initial configuration of the RHS applied to the current channel state, until a termination condition is met, wherein causing the RHS to be configured may be based on one of the plurality of candidate configurations having a difference value that satisfies the condition.

According to a second aspect of the disclosure, there is provided a computer program comprising instructions which, when the program is executed by a computer, cause the computer to carry out the method of the first aspect of the disclosure. The computer program may be stored on a computer readable carrier medium. According to a third aspect of the disclosure, there is provided a device for a wireless telecommunications network, the wireless telecommunications network comprising a Reconfigurable Holographic Surface (RHS) and a communication channel, the device comprising a processor configured to implement the method of the first aspect of the disclosure. The device may be a component of the RHS. According to a fourth aspect of the disclosure, there is provided a system comprising: a Reconfigurable Holographic Surface (RH) S; and a device of the third aspect of the disclosure.

### BRIEF DESCRIPTION OF THE FIGURES

In order that the present disclosure may be better understood, embodiments thereof will now be described, by way of example only, with reference to the accompanying drawings in which:

FIG. 1 is a schematic diagram of a wireless telecommunications network.

FIG. 2 is a system model of the wireless telecommunications network of FIG. 1.

FIG. 3 is a schematic diagram of a Reconfigurable Holographic Surface (RHS) of the wireless telecommunications network of FIG. 1.

FIG. 4 is a system model of the wireless telecommunications network of FIG. 1.

FIG. 5 is a flow diagram illustrating a process of predicting a future channel state matrix.

FIG. 6 is a schematic diagram of a LSTM-assisted channel state matrix predictor.

FIG. 7 is a flow diagram illustrating a process of determining the optimal RHS configuration matrix.

FIG. 8 is a flow diagram illustrating a method of configuring the RHS.

### DETAILED DESCRIPTION

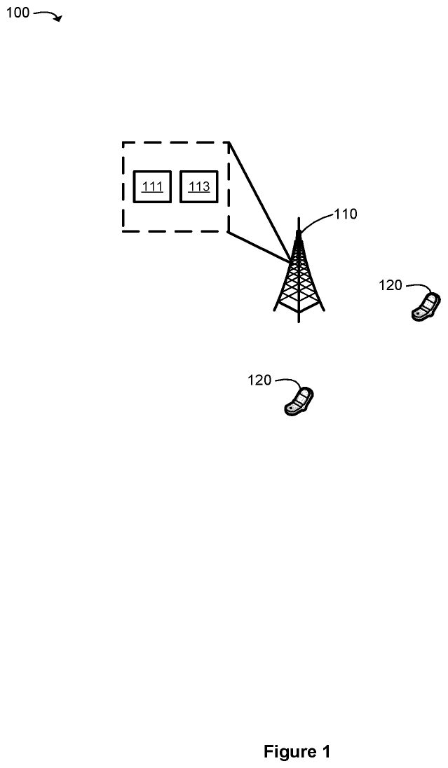

FIG. 1 illustrates a wireless telecommunications network 100 comprising an access point 110 (which may be, for example, a base station if the wireless telecommunications network 100 is a cellular telecommunications network) and a plurality of user equipment 120. The access point 110 includes a processing module 111 and a Reconfigurable Holographic Surface (RHS) 113. The access point 110 is configured to receive, from a core network (not shown), a plurality of data streams K at K input data ports, wherein each data stream of the plurality of data streams is destined for a particular user equipment of the plurality of user equipment 120. The RHS 113 comprises a plurality of radiation elements. In this example in which the RHS is a 2-dimensional RHS, the plurality of antenna elements are arranged in U rows and V columns.

A signal, y, transmitted by the access point 110 may be represented as:

$$y = HBWs + σ \qquad ( 1 )$$

In which:
y∈ [symbol] ^{K×1} represents data transmitted by the access point via the RHS 113;
s∈ [symbol] ^{K×1} represents data of a received data stream of the plurality of data streams K;
o∈ [symbol] ^{K×1} represents noise;
H∈ [symbol] ^{K×UV} is a channel matrix representing a channel between the access point (more specifically, the RHS 113) and each user equipment of the plurality of user equipment 120 (described in more detailed below);
W∈ [symbol] ^{N×K} is a beamforming matrix (described in more detail below); and
B∈ [symbol] ^{UV×N} is an RHS configuration matrix (described in more detail below).

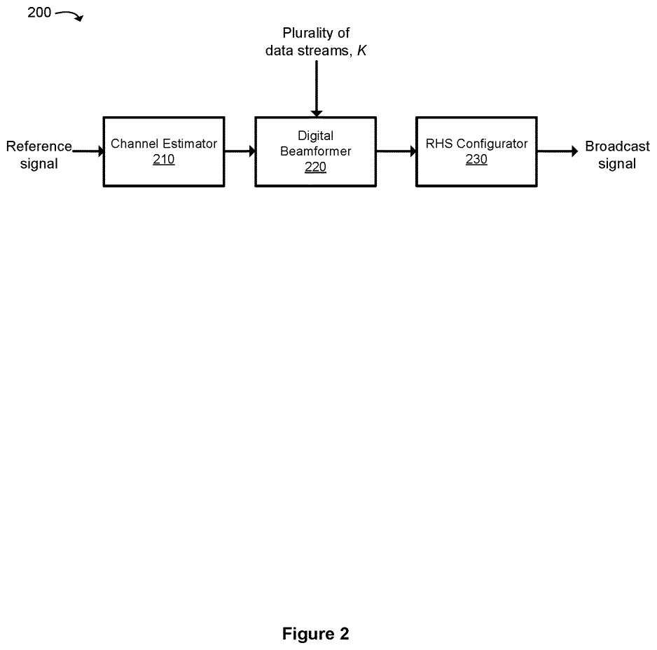

FIG. 2 is a system model 200 of the wireless telecommunications network 100 comprising a channel estimator 210, a digital beamformer 220 and an RHS configurator 230. The channel estimator 210 is a functional block for implementing a channel estimation technique to estimate a channel state matrix, Ĥ, of the channel between the access point 110 and each user equipment of the plurality of user equipment 120. The channel estimation technique may be, for example, any one of the techniques described in chapter “Channel estimation” in “Introduction to MIMO Communications” (pp. 214-231). Hampton, J. (2013), Cambridge: Cambridge University Press and may be implemented by the access point 110 in cooperation with each user equipment of the plurality of user equipment 120. As shown in FIG. 2, the channel estimation technique may be based on the transmission of known reference signals between the access point 110 and each user equipment of the plurality of user equipment 120.

The system model also illustrates the plurality of data streams, K, to be transmitted by the access point 110 to the plurality of user equipment 120. The digital beamformer 220 is a functional block for performing baseband signal processing of the plurality of data streams, K, using (for example) the processing module 111 of the access point 110, based on the estimated channel, Ĥ, to output the beamforming matrix, W. The beamforming matrix, W, may be computed using, for example, a zero-forcing method. The digital beamformer 220 outputs the beamforming matrix, W, to N Radio Frequency (RF) chains. Each RF chain receives the beamforming matrix, W, and transforms the received signal to an electromagnetic wave, hereinafter the “reference wave”.

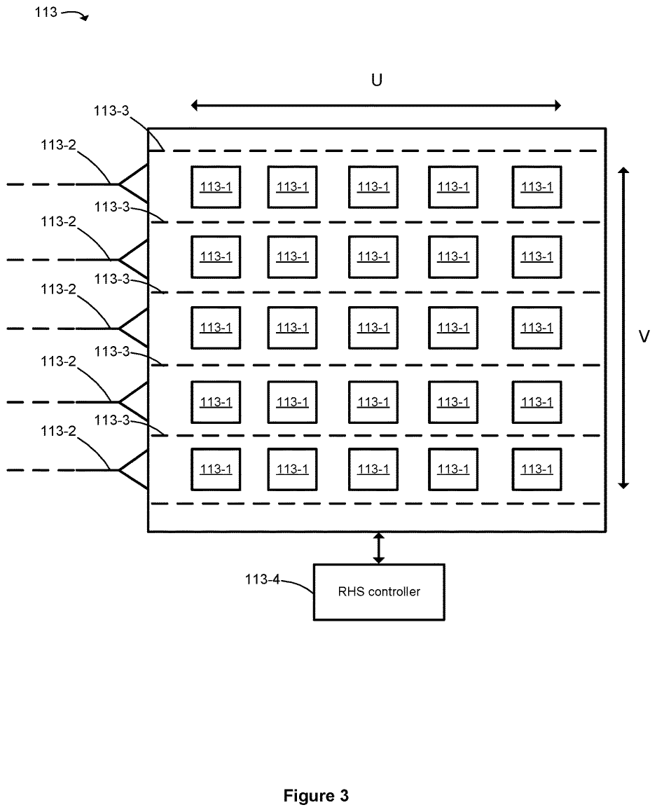

The RHS 113 will now be described in more detail with reference to FIG. 3. The RHS 113 is a planar structure and comprises the plurality of radiation elements 113-1, a plurality of feeds 113-2, a plurality of waveguides 113-3 and an RHS controller 113-4 (implementing the RHS configurator functional block 230, described in more detail below). Each feed 113-2 of the plurality of feeds 113-2 is positioned at one end of a particular row of the plurality of radiation elements 113-1 and provides a particular reference wave (received from a particular RF chain) to a waveguide 113-3 of the plurality of waveguides 113-3. The waveguide 113-3 then guides the reference wave along that particular row such that the guided reference wave excites each radiation element 113-1 of that particular row. The reference wave therefore serially excites each radiation element 113-1 of that row. Each radiation element 113-1 is controlled by the RHS controller 113-4 with a particular electrical and/or magnetic bias. For example, if the radiation element 113-1 has the form of a p-i-n diode or varactor diode, as described for example in paper “Reconfigurable Holographic Surface A New Paradigm to Implement Holographic Radio”, Deng et al, page 23, then the radiation element 113-1 may be controlled by applying a bias electrical potential difference to the p-i-n diode. When excited by the reference wave, the radiation element 113-1 emits an object wave as a function of the reference wave and the controller bias. This will now be explained.

The reference wave, ψ_{ref}, may be represented as:

$${ψ}_{ref} ( {r}_{u , v}^{n} ) = {e}^{- j {t}_{s} \cdot {r}_{u , ν}^{n}} \qquad ( 2 )$$

In which:
j is the imaginary unit;
tₛ is a directional propagation vector of the reference wave; and

$${r}_{u , v}^{n}$$

is a distance vector from the n-th RF feed to the (u,v)-th radiation element 113-1 of the RHS 113.

The object wave, ψ_{obj}, as emitted by the radiation element 113-1, may be represented as:

$${ψ}_{obj} ( {r}_{u , v} , θ , ϕ ) = {e}^{- j {t}_{f} ( θ , ϕ ) \cdot {r}_{u , ν}} \qquad ( 3 )$$

In which:
t_{f}(θ,φ) is a desired directional propagation vector of the object wave; and
r_{u,v} is a position vector of the (u,v)-th radiation element 113-1 of the RHS 113.

The interference between the reference wave and the desired object wave, ψ_{intf}, may be represented as:

$${ψ}_{intf} ( {r}_{u , v}^{n} , θ , ϕ ) = {ψ}_{obj} ( {r}_{u , v}^{n} , θ , ϕ ) \overline{{ψ}_{ref} ( {r}_{u , v}^{n} )} \qquad ( 4 )$$

The holographic pattern may be regarded as a M×N matrix, hereinafter the RHS radiation matrix, M, in which the (m, n)-th matrix element is based on equation (4) above using the real part normalized between 0 and 1, i.e.

$$M ( {r}_{u , v}^{n} , θ , ϕ ) = \frac{R e [ {ψ}_{intf} ( {r}_{u , v}^{n} , θ , ϕ ) ] + 1}{2} \qquad ( 5 )$$

An RHS configuration matrix, B, may be derived from the RHS radiation matrix M as:

$${B}_{[ v + ( u - 1 ) V ] , n} = {M}_{u , v} \cdot {e}^{- j {t}_{s} \cdot {r}_{u , ν}^{n}} \qquad ( 6 )$$

The RHS controller 113-4, implementing the RHS configurator functional block 230, may therefore determine an RHS configuration matrix, B, so as to control the radiation amplitude of the reference wave at each radiation element 113-1 such that, when excited by the reference wave, the RHS 113 emits the desired object wave having the desired directional propagation vector. In system model 200, the RHS configuration matrix, B, is based on an estimate (e.g. the most recent estimate) of the channel state matrix, as estimated by the channel estimator 210 based on reference signals previously transmitted between the access point 110 and each user equipment of the plurality of user equipment 120.

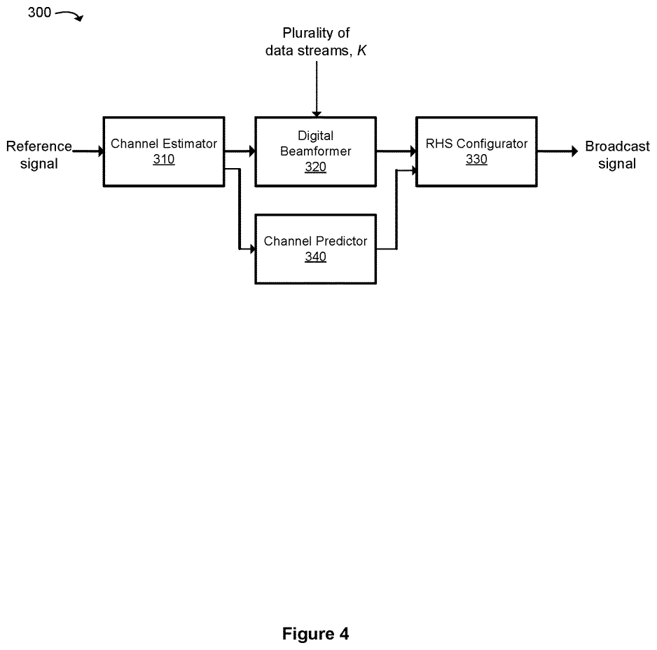

A further system model 300 is illustrated in FIG. 4. The system model 300 comprises a channel estimator 310, a digital beamformer 320 and an RHS configurator 330, similar to the system model 200 of FIG. 2. However, system model 300 also comprises a channel predictor 340, which will be explained in more detail below.

The channel estimator 310 and digital beamformer 320 functional blocks operate in the same or similar manner to the system model 200 of FIG. 2 described above so as to output a channel state matrix estimate, Ĥ_{L} (in which subscript L indicates that the channel state matrix was estimated at time instance L), and a beamforming matrix, W. However, in the system model 300 of FIG. 4, a plurality of channel state matrices estimated by the channel estimator 310 are also provided to the channel predictor 340. The channel predictor 340, which may be implemented by the processing module 111 of the access point 110, is configured to predict a future channel state matrix based on the plurality of channel state matrices estimated by the channel estimator 310.

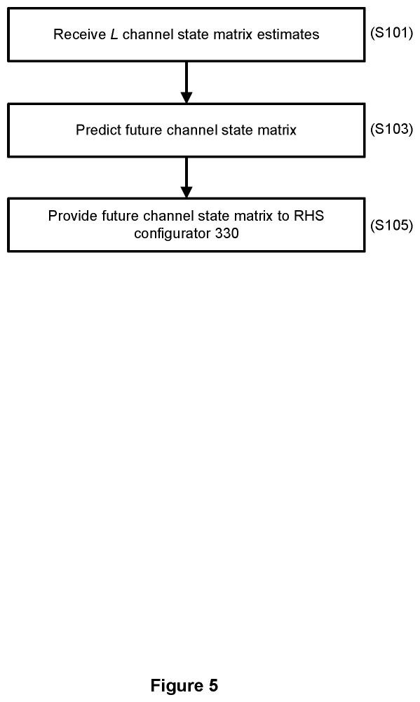

A process of predicting a future channel state matrix is illustrated in FIG. 5. In S101, the channel predictor 340 receives L channel state matrix estimates—Ĥ₁ to Ĥ_{L}—from the channel estimator 310 corresponding to channel state matrices H₁ to H_{L}. In S103, the channel predictor 340 predicts at least one future channel state matrix, Ĥ_{L+F}, based on the received L channel state matrix estimates, Ĥ₁ to Ĥ_{L}, using a time-series forecast technique. In some embodiments, the predicted future channel state matrix corresponds to the channel state matrix at a future time instance, L+F, when the RHS 113 of the access point 110 transmits the signal. The channel predictor 340 may predict a plurality of future channel state matrices, Ĥ_{L+1} to Ĥ_{L+F}, based on the received L channel state matrix estimates using the time-series forecast technique. In S105, the one or more predicted future channel state matrices, Ĥ_{L+1} to Ĥ_{L+F}, are provided to RHS configurator 330.

An example of a time-series forecast technique for use in S103 of FIG. 5 will now be described in more detail. The goal of the time-series forecast technique is to predict future instances in a sequence of temporally correlated data samples—the received L channel state matrix estimates—Ĥ₁ to Ĥ_{L}. The time variation of a real-world wireless channel exhibits non-trivial temporal correlation, usually as a superposition of multiple Doppler effects. Deep learning (i.e. deep neural networks) may be used to predict the future channel state matrix estimate(s). The deep-learning-assisted channel state matrix prediction involves an initial training process that aims to maximize the similarity between the predicted future channel state matrix, Ĥ_{L+F}, and the actual channel, H_{L+F}, at a time instance of the predicted future channel state matrix.

One example deep-learning-assisted time-series forecast technique is a long short term memory (LSTM) recurrent neural network. The LSTM recurrent neural network can learn both long and short term correlation in a given time series in some embodiments. This is achieved by the three gates of each LSTM neuron, i.e., a forget gate, an input gate and an output gate in addition to a memory buffer that is iteratively updated based on the outcome of the forget and input gates.

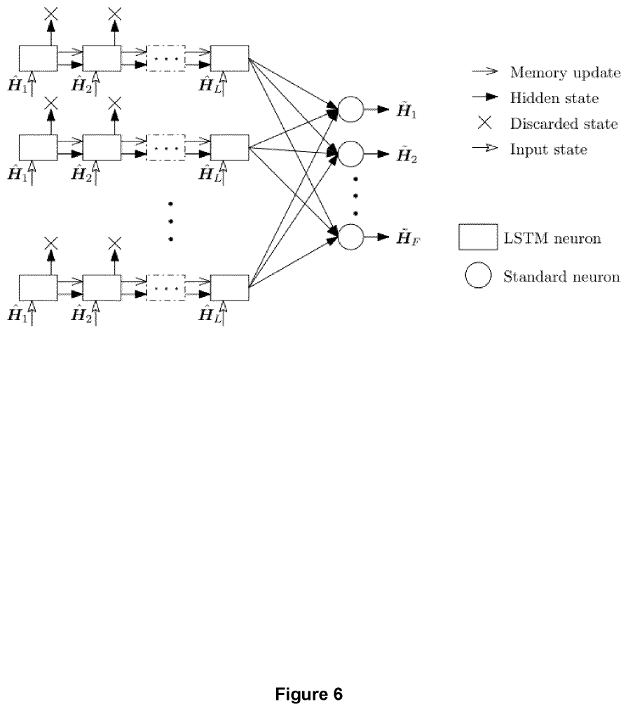

FIG. 6 illustrates a LSTM-assisted channel state matrix predictor. A LSTM layer consists of a plurality of (potentially interacting) chains of LSTM neurons followed by a conventional (i.e. non-LSTM) fully connected neural network to perform the channel state matrix prediction. The prediction framework may be defined as a mapping, [symbol] :

$${\hat{H}}_{L + F} = 𝕄 ( \{ {\hat{H}}_{l} , ∀ l = 1 , 2 , … , L \} ) ∀ f = 1 , 2 , … , F \qquad ( 7 )$$

The training process of the channel predictor 340 is therefore based on maximizing the similarity between the predicted future channel state matrix, Ĥ_{L+F}, and the actual channel state matrix, H_{L+F}, at a time instance of the predicted future channel state matrix. A possible loss function, L, (i.e. to be minimized) is:

$$ℒ = {\sum }_{f = 1}^{F} {‖ vec ( {H}_{L + F} - {\hat{H}}_{L + F} ) ‖}^{2} \qquad ( 8 )$$

This training may be performed offline by the channel predictor 340 based on a supervised learning technique (i.e. a collection of known channel state matrices), and the trained LSTM recurrent neural network may then be used by the channel predictor 340 in S103 based on the L channel state matrix estimates received in S101. The skilled person will understand that any other time-series forecasting technique may also be used, including regression or any one of the techniques described in A. Duel-Hallen, “Fading Channel Prediction for Mobile Radio Adaptive Transmission Systems,” in Proceedings of the IEEE, vol. 95, no. 12, pp. 2299-2313 December 2007.

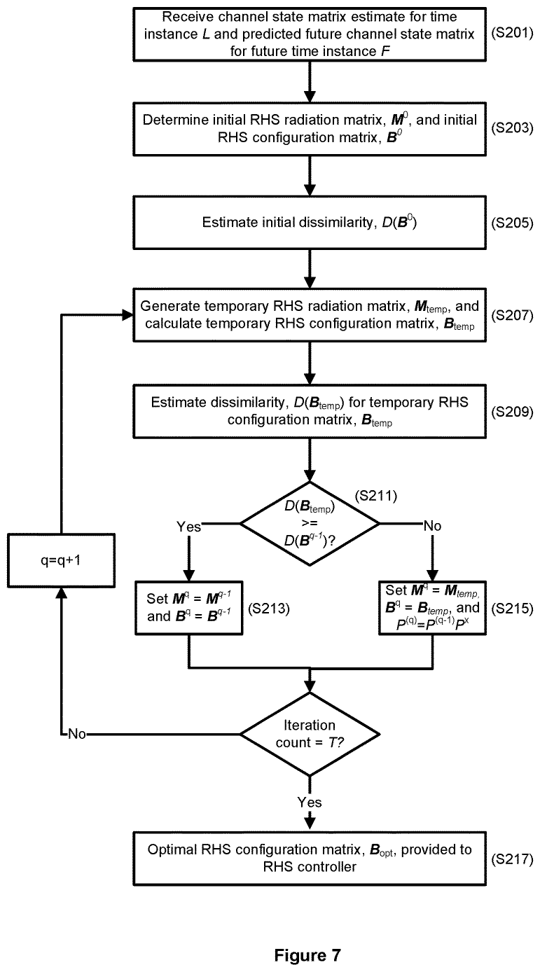

As noted above, in S105, the one or more predicted future channel state matrices, Ĥ_{L+1} to Ĥ_{L+F}, are provided to RHS configurator 330. The RHS configurator 330 is configured to determine an optimal RHS configuration matrix, Bₒₚₜ, based on any one of the predicted future channel state matrices, Ĥ_{L+1} to Ĥ_{L+F} (but in some embodiments the predicted future channel state matrix of the time instance L+F, Ĥ_{L+F}, when the RHS 113 transmits the signal). A process of determining the optimal RHS configuration matrix, Bₒₚₜ, will now be described with reference to FIG. 7.

In S201, the RHS configurator 330 receives a channel state estimate for time instance L, Ĥ_{L}, from the channel estimator 310, and a predicted future channel state matrix for future time instance L+F, Ĥ_{L+F}, from the channel predictor 340. The RHS configurator 330 also determines:
the RHS radiation matrix for time instance L, M_{L}, based on equation (5) above;
the reference wave ψ_{ref}

$$( {r}_{u , v}^{n} )$$

based on equation (2) above;
the RHS configuration matrix for time instance L, B_{L}, based on M_{L} when excited by the reference wave ψ_{ref}

$$( {r}_{u , v}^{n} ) ;$$

an initial update probability, P⁽⁰⁾, as 0<P⁽⁰⁾<1;
an update rate, P^{x}, as 0<P^{x}<1; and
a total number of iterations, T, (e.g. T=100).

The RHS configurator 330 then determines Bₒₚₜ as:

$${B}_{opt} = {arg min}_{B ∈ {ℂ}^{U V \times N}} {‖ vec ( {\hat{H}}_{L + F} B - {\hat{H}}_{L} {B}_{L} ) ‖}^{2} \qquad ( 9 )$$

In this example, the RHS configurator 330 solves equation (9) using a simulated annealing technique, in which the plurality of radiation elements 113-1 of the RHS are controlled by applying a binary electrical potential difference (e.g. 0.25 or 0.75). In more detail, in S203, the RHS configurator 330 determines an initial RHS radiation matrix M⁰, as M_{L}, and an initial RHS configuration matrix, B⁰, as B_{L}.

In S205, the RHS configurator 330 estimates an initial dissimilarity, D, between 1) the initial RHS configuration matrix, B⁰, applied to the predicted future channel state matrix for time instance L+F, Ĥ_{L+F}, and 2) the RHS configuration matrix for time instance L, B_{L}, applied to the channel state matrix estimate for time instance L, Ĥ_{L}, i.e.

$$D ( {B}^{0} ) = {‖ vec ( {\hat{H}}_{L + F} {B}^{0} - {\hat{H}}_{L} {B}_{L} ) ‖}^{2} \qquad ( 10 )$$

The RHS configurator 330 then enters an iterative loop for q=1, 2 . . . . T. In S207, of the iterative loop, the RHS configurator 330 generates a temporary RHS radiation matrix, Mₜₑₘₚ, by switching (between the binary values) each element of M^{q-1} with probability p^{(q-1)}, and calculates a temporary RHS configuration matrix Bₜₑₘₚ (as Mₜₑₘₚ when excited by the reference wave, ψ_{ref}

$$( {r}_{u , v}^{n} ) ) .$$

In S209, the RHS configurator 330 estimates a dissimilarity (D) between 1) the temporary RHS configuration matrix, Bₜₑₘₚ, applied to the predicted future channel state matrix for time instance L+F, Ĥ_{L+F}, and 2) the RHS configuration matrix for time instance L, B_{L}, applied to the channel state matrix estimate for time instance L, Ĥ_{L}, i.e.

$$D ( {B}_{temp} ) = {‖ vec ( {\hat{H}}_{L + F} {B}_{temp} - {\hat{H}}_{L} {B}_{L} ) ‖}^{2} \qquad ( 11 )$$

In S211, the RHS configurator 330 determines whether the dissimilarity, D, for Bₜₑₘₚ of the current iteration is greater than or equal to the dissimilarity, D, for the previous iteration (i.e. in the first iteration, this comparison is based on the initial dissimilarity (D) determined in S205), i.e.

$$D ( {B}_{temp} ) \geq D ( {B}^{( q - 1 )} ) \qquad ( 12 )$$

$${‖ vec ( {\hat{H}}_{L + F} {B}_{temp} - {\hat{H}}_{L} {B}_{L} ) ‖}^{2} \geq {‖ vec ( {\hat{H}}_{L + F} {B}^{( q - 1 )} - {\hat{H}}_{L} {B}_{L} ) ‖}^{2}$$

If the determination of S211 is affirmative, such that D (Bₜₑₘₚ) is greater than or equal to D(B^{(q-1)}) then, in S213, the RHS radiation matrix for the current iteration, M^{q}, is set as the RHS radiation matrix for the previous iteration, M^{q-1}, and the RHS configuration matrix for the current iteration, B^{q}, is set as the RHS configuration matrix for the previous iteration, B^{q-1}. If the determination of S211 is negative, such that D (Bₜₑₘₚ) is less than D(B^{(q-1)}) then, in S215, the RHS radiation matrix for the current iteration, M^{q}, is set as the temporary RHS radiation matrix, Mₜₑₘₚ, the RHS configuration matrix for the current iteration, B^{q}, is set as the temporary RHS configuration matrix Bₜₑₘₚ, and the update probability for the current iteration, P^{(q)}, is set as the update probability for the previous iteration P^{(q-1)} multiplied by the update rate P^{x}. The adjustment to the update probability will (in general) speed up convergence.

The iterations of S207 to S213/S215 are repeated for the total number of iterations, T. On completion of the final iteration, T, the RHS configurator 330 has determined an optimal RHS radiation matrix, Mₒₚₜ as the RHS radiation matrix calculated in the final iteration and the optimal RHS configuration matrix, Bₒₚₜ as the RHS configuration matrix calculated in the final iteration.

In S217, the optimal RHS configuration matrix is provided to the RHS controller, which applies the electrical and/or magnetic bias to each radiation element of the RHS 113 according to the optimal RHS configuration matrix at time instance L+F.

The system model 300 provides an improved method of configuring an RHS relative to system model 200. In system model 200, the RHS is configured based on an RHS configuration matrix that is determined from a historical channel state matrix estimate (that is, it is based on previously transmitted reference signals between the access point 110 and the plurality of user equipment 120). Thus, the channel may change between the time of the historical channel state matrix estimate and the time the signal is transmitted by the RHS 113, such that the transmitted signal is not optimized for the channel at the time of transmission. This “channel aging” problem is addressed by system model 300, in which the RHS 113 is configured based on an RHS configuration matrix that is determined from a predicted future channel state matrix at a future time instance (i.e. relative to the time instance of the last channel state estimate by the channel estimator 310, and in some embodiments a future time instance corresponding with the transmission of the signal by the RHS 113). The RHS 113 is therefore more likely to be configured according to the actual channel at the time of transmission, such that the wireless telecommunications network 100 achieves improved sum-rate of communications.

The skilled person will understand that it is not essential that the wireless telecommunications network 100 includes a plurality of user equipment 120, and the processes above may apply to a communication between a single access point 110 and a single user equipment. Furthermore, the processes may apply to a communication from any form of transmitter (implementing an RHS) to one or more receivers.

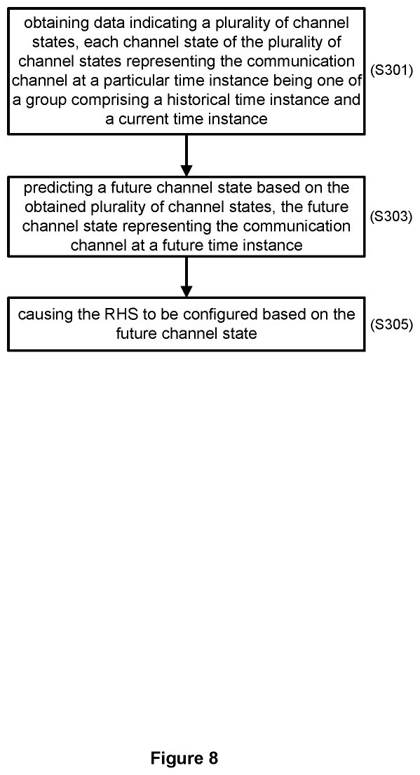

The skilled person will also understand that it the simulated annealing process above is non-essential, and any other method of determining an RHS configuration matrix based on the predicted future channel state matrix may be implemented instead. The determination may therefore be based on other forms of optimization technique. For example, the process of FIG. 7 may involve fewer steps such that one or more candidate RHS configuration matrices are determined, and if the dissimilarity value for these one or more candidate RHS configuration matrices satisfies a condition (e.g. being less than a threshold), then the one or more candidate RHS configuration matrices may be used as the optimized RHS configuration matrix. The method of configuring an RHS may therefore be represented as the flow diagram of FIG. 8 comprising: S301: obtaining data indicating a plurality of channel states, each channel state of the plurality of channel states representing the communication channel at a particular time instance being one of a group comprising a historical time instance and a current time instance; S303: predicting a future channel state based on the obtained plurality of channel states, the future channel state representing the communication channel at a future time instance; and S305: causing the RHS to be configured based on the future channel state.

The skilled person will also understand that the above processes apply to other forms of RHS, such as a one-dimensional RHS. The skilled person will understand that in some examples, such as when the network includes a single receiver having a single antenna and the RHS is a one-dimensional RHS, then the channel may be represented as a single channel state rather than a channel state matrix.

The skilled person will also understand that it is non-essential for the channel estimation to use actual measurements of the channel, as a blind channel estimation technique may be used instead.

The skilled person will understand that it is non-essential for the various processes, or steps of the various processes, to be implemented by the particular components of the wireless telecommunications network 100 mentioned above. Instead, any processing module (or plurality of distributed processing modules) may implement these steps.

The skilled person will understand that any combination of features is possible within the scope of the disclosure, as claimed.

1. A method of configuring a Reconfigurable Holographic Surface (RHS) in a wireless telecommunications network, comprising a communication channel between the RHS and a receiver, the method comprising:
obtaining data indicating a plurality of channel states, each channel state of the plurality of channel states representing one or more properties of the communication channel at a particular time instance being one of a group comprising a historical time instance and a current time instance;
predicting a future channel state based on the obtained plurality of channel states, the future channel state representing the communication channel at a future time instance; and
causing the RHS to be configured based on the future channel state.

2. The method as claimed in claim 1, wherein the future time instance represents a time the RHS transmits a signal to the receiver.

3. The method as claimed in claim 1, wherein predicting a future channel state uses a time series forecast technique.

4. The method as claimed in claim 3, wherein the time series forecast technique is based on a long short term memory recurrent neural network.

5. The method as claimed in claim 1, wherein the data indicating the plurality of channel states includes a current channel state representing the communication channel at the current time instance, and configuring the RHS based on the future channel state comprises:
determining an initial configuration of the RHS,
determining a difference value between a candidate configuration of the RHS applied to the future channel state and the initial configuration of the RHS applied to the current channel state,
determining that the difference value satisfies a condition, and
causing the RHS to be configured based on the candidate configuration of the RHS.

6. The method as claimed in claim 5, wherein determining the difference value is repeated iteratively for a plurality of candidate configurations of the RHS, each iteration comprising determining a difference value between one of the plurality of candidate configurations of the RHS applied to the future channel state and the initial configuration of the RHS applied to the current channel state, until a termination condition is met, wherein causing the RHS to be configured is based on one of the plurality of candidate configurations having a difference value that satisfies the condition.

7. A computer program comprising instructions which, when the program is executed by a computer, cause the computer to carry out the method of claim 1.

8. A non-transitory computer readable carrier medium comprising computer program instructions which, when the computer program is executed by a computer, cause the computer to carry out the method of claim 1.

9. A device for a wireless telecommunications network comprising a Reconfigurable Holographic Surface (RHS) and a communication channel, the device comprising a processor configured to implement the method of claim 1.

10. The device as claimed in claim 9, wherein the device is a component of the RHS.

11. A system comprising:
a Reconfigurable Holographic Surface (RHS); and
the device as claimed in claim 9.
